(19) United States
(12) Patent Application Publication
(10) Pub. No.: US 2017/0046212 A1
(43) Pub. Date: Feb. 16, 2017

(54) REDUCING SYSTEM DOWNTIME DURING MEMORY SUBSYSTEM MAINTENANCE IN A COMPUTER PROCESSING SYSTEM

(71) Applicant: QUALCOMM Incorporated, San Diego, CA (US)

(72) Inventors: Carlos Alberto Fernandez, Austin, TX (US); Joab Daniel Henderson, Austin, TX (US); Michael Louis Hobbs, Austin, TX (US)

(21) Appl. No.: 14/825,495

(22) Filed: Aug. 13, 2015

(51) Int. Cl. G06F 11/07; G06F 3/06

(52) U.S. Cl. CPC G06F 11/079; G06F 11/073; G06F 11/0751; G06F 3/0617; G06F 3/0653; G06F 3/0679

(57) ABSTRACT

Reducing system downtime during memory subsystem maintenance in a computer processing system is disclosed. In some aspects, a computer processing system comprises a computer processor communicatively coupled to a plurality of memory sockets, each of which interfaces with a memory module and includes a gate control. The computer processor is further communicatively coupled to a dedicated non-volatile storage device. Upon detection of a memory health condition requiring replacement of a memory module, access to the memory module is blocked, and data is transferred from the memory module to the dedicated non-volatile storage device. A memory address range of the memory module is then remapped to the dedicated non-volatile storage device, such that subsequent memory access requests to the memory module are rerouted to the dedicated non-volatile storage device. The memory socket of the memory module is then gated, allowing maintenance to be performed while maintaining system availability.

### BACKGROUND

I. Field of the Disclosure

The technology of the disclosure relates generally to computer architectures providing support for random access memory modules.

II. Background

Modern computing systems, such as datacenter servers, are often responsible for executing mission-critical software applications. Such applications may represent critical assets for organizations, and thus the applications may require near-constant system availability. As a result, prevailing information technology (IT) practices seek to minimize any system downtime required to accomplish tasks such as repairs or upgrades to server subsystems.

However, minimizing system downtime may be complicated by conventional computer architectures, which may not allow for “live” system maintenance (i.e., repairs or upgrades performed while the server is in an operational state) of server subsystems. In the particular case of memory subsystems, a server that is based on a conventional computer architecture may be unable to continue operations while a memory module, such as a dual in-line memory module (DIMM), is being added to or removed from the server. Instead, the server must be “taken offline,” or shut down entirely, for the duration of the maintenance activity. This may result in system downtime that has a negative effect on overall system availability.

Moreover, IT professionals may be unable to preemptively detect and diagnose an impending failure of a specific memory module of a server. Consequently, IT professionals may face greater difficulty in mitigating the effects of unexpected system downtime.

### SUMMARY OF THE DISCLOSURE

Aspects disclosed in the detailed description include reducing system downtime during memory subsystem maintenance. Related systems, apparatuses, methods, and computer-readable media are also disclosed. In this regard, in some exemplary aspects disclosed herein, a computer processing system is provided for monitoring memory health conditions of memory modules. The computer processing system enables memory module replacement without requiring the computer processing system to be taken offline. The computer processing system comprises a computer processor communicatively coupled to a plurality of memory sockets, each of which interfaces with a memory module, such as a dual in-line memory module (DIMM) as an example. Each of the memory sockets includes a gate control enabling voltage gating and, in some aspects, clock gating of the memory socket. The computer processor is further communicatively coupled via a high-speed serial device channel to a dedicated non-volatile storage device, such as a solid-state drive (SSD), as a non-limiting example. The computer processing system may act in concert with a memory monitoring agent to detect and monitor memory health conditions, such as memory error conditions and user-initiated upgrade requests, as non-limiting examples. If a memory health condition is detected in a memory module, the memory monitoring agent may determine that replacement of the memory module is warranted. Accordingly, access to the memory module may be blocked, and data is transferred from the memory module to the dedicated non-volatile storage device. A memory address range of the memory module can then be remapped to the dedicated non-volatile storage device, such that subsequent memory access requests to the memory module are rerouted to the dedicated non-volatile storage device. Voltage gating (and, optionally, clock gating) may be applied to the memory socket, allowing the memory module to be removed and replaced while the computer processing system remains operational. In this manner, downtime for the computer processing system may be reduced while maintenance is performed on the memory module.

In another aspect, a computer processing system is provided. The computer processing system comprises a plurality of memory sockets, each comprising a gate control and configured to interface with a memory module. The computer processing system further comprises a dedicated non-volatile storage device. The computer processing system also comprises a computer processor that is communicatively coupled to the plurality of memory sockets and to the dedicated non-volatile storage device. The computer processor is configured to detect a memory health condition for a memory module interfaced with a memory socket among the plurality of memory sockets. The computer processor is additionally configured to identify the memory module interfaced with the memory socket of the plurality of memory sockets as a source of the memory health condition. The computer processor is further configured to transfer data stored in the memory module to the dedicated non-volatile storage device. The computer processor is also configured to cause voltage gating to be applied to the memory socket using the gate control of the memory socket to render the memory socket inactive.

In another aspect, a computer processing system is provided. The computer processing system comprises a means for detecting a memory health condition for a memory module interfaced with a memory socket among a plurality of memory sockets. The computer processing system further comprises a means for identifying the memory module interfaced with the memory socket of the plurality of memory sockets as a source of the memory health condition. The computer processing system also comprises a means for transferring data stored in the memory module to a dedicated non-volatile storage device. The computer processing system additionally comprises a means for causing voltage gating to be applied to the memory socket to render the memory socket inactive.

In another aspect, a method for facilitating maintenance of a computer processing system is provided. The method comprises receiving an indication of a memory health condition of a memory module of a plurality of memory modules of a computer processing system. The method further comprises determining whether the memory health condition warrants replacement of the memory module. The method also comprises, responsive to determining that the memory health condition warrants the replacement of the memory module, blocking access to a memory address range of the memory module based on receiving the indication of the memory health condition. The method additionally comprises, responsive to determining that the memory health condition warrants the replacement of the memory module, initiating a transfer of data stored in the memory module to a dedicated non-volatile storage device of the computer processing system. The method further comprises, responsive to determining that the memory health condition warrants the replacement of the memory module, remapping the memory address range of the memory module to the dedicated non-volatile storage device.

In another aspect, a non-transitory computer-readable medium is provided, having stored thereon computer-executable instructions which, when executed by a processor, cause the processor to receive an indication of a memory health condition of a memory module of a plurality of memory modules of a computer processing system. The computer-executable instructions further cause the processor to determine whether the memory health condition warrants replacement of the memory module. The computer-executable instructions also cause the processor to, responsive to determining that the memory health condition warrants the replacement of the memory module, block access to a memory address range of the memory module based on receiving the indication of the memory health condition. The computer-executable instructions additionally cause the processor to, responsive to determining that the memory health condition warrants the replacement of the memory module, initiate a transfer of data stored in the memory module to a dedicated non-volatile storage device of the computer processing system. The computer-executable instructions further cause the processor to, responsive to determining that the memory health condition warrants the replacement of the memory module, remap the memory address range of the memory module to the dedicated non-volatile storage device.

### BRIEF DESCRIPTION OF THE FIGURES

FIG. 1 is a block diagram of an exemplary computer processing system including a computer processor configured to detect a memory health condition and transfer data to and from a dedicated non-volatile storage device to reduce system downtime during memory subsystem maintenance;

FIGS. 2A-2F are block diagrams illustrating operations of the computer processing system of FIG. 1 for enabling “live” memory subsystem maintenance in response to detection of a memory health condition in a memory module;

FIGS. 3A-3C are flowcharts illustrating exemplary operations by both software and hardware elements of the computer processing system of FIG. 1 for monitoring memory health conditions and reducing system downtime during memory subsystem maintenance; and

FIG. 4 is a block diagram of an exemplary processor-based system that can include the computer processing system of FIG. 1.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include reducing system downtime during memory subsystem maintenance. Related systems, apparatuses, methods, and computer-readable media are also disclosed. In this regard, in some exemplary aspects disclosed herein, a computer processing system is provided for monitoring memory health conditions of memory modules. The computer processing system enables memory module replacement without requiring the computer processing system to be taken offline. The computer processing system comprises a computer processor communicatively coupled to a plurality of memory sockets, each of which interfaces with a memory module, such as a dual in-line memory module (DIMM) as an example. Each of the memory sockets includes a gate control enabling voltage gating and, in some aspects, clock gating of the memory socket. The computer processor is further communicatively coupled via a high-speed serial device channel to a dedicated non-volatile storage device, such as a solid-state drive (SSD), as a non-limiting example. The computer processing system may act in concert with a memory monitoring agent to detect and monitor memory health conditions, such as memory error conditions and user-initiated upgrade requests, as non-limiting examples. If a memory health condition is detected in a memory module, the memory monitoring agent may determine that replacement of the memory module is warranted. Accordingly, access to the memory module may be blocked, and data is transferred from the memory module to the dedicated non-volatile storage device. A memory address range of the memory module can then be remapped to the dedicated non-volatile storage device, such that subsequent memory access requests to the memory module are rerouted to the dedicated non-volatile storage device. Voltage gating (and, optionally, clock gating) may be applied to the memory socket, allowing the memory module to be removed and replaced while the computer processing system remains operational. In this manner, downtime for the computer processing system may be reduced while maintenance is performed on the memory module.

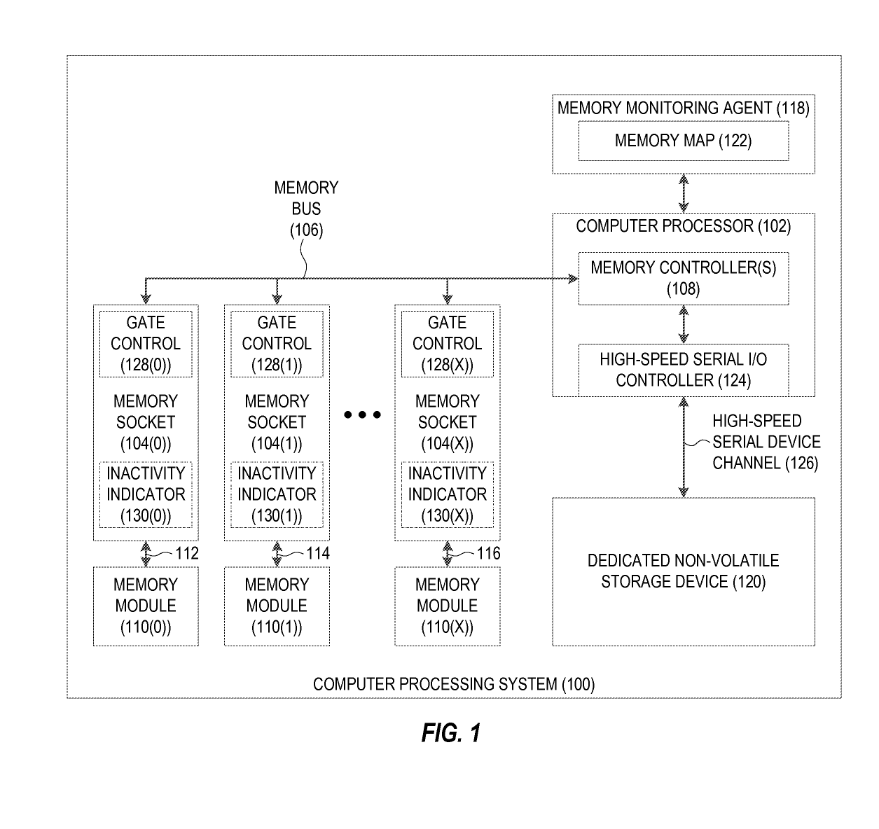

In this regard, FIG. 1 is a block diagram of an exemplary computer processing system 100. The computer processing system 100 includes a computer processor 102 configured to reduce system downtime by enabling detection of memory health conditions and facilitating “live” memory subsystem maintenance. The computer processing system 100 and the computer processor 102 may encompass any one of known digital logic elements, semiconductor circuits, processing cores, and/or memory structures, among other elements, or combinations thereof. Aspects described herein are not restricted to any particular arrangement of elements, and the disclosed techniques may be easily extended to various structures and layouts on semiconductor dies or packages.

The computer processing system 100 also includes memory sockets 104(0)-104(X), which are communicatively coupled via a memory bus 106 to a memory controller 108 of the computer processor 102. The memory sockets 104(0)-104(X) are configured to interface with corresponding memory modules 110(0)-110(X), as indicated by bidirectional arrows 112, 114, and 116. Some aspects may provide that the memory sockets 104(0)-104(X) each comprise a DIMM slot configured to interface with double data rate synchronous dynamic random-access memory (DDR SDRAM), DDR2 SDRAM, DDR3 SDRAM, or DDR4 SDRAM, as non-limiting examples. In some aspects, each of the memory modules 110(0)-110(X) may comprise a DIMM module providing one or more of the above-enumerated SDRAM variants, as non-limiting examples.

The computer processor 102 of FIG. 1 is configured to execute or otherwise communicate with software (not shown) that, among other functionality, is responsible for providing access for executing processes to each of the memory modules 110(0)-110(X) of the computer processing system 100. In some aspects, the software may comprise a hypervisor (also known as a virtual machine monitor, not shown) that creates and manages execution of operating system software (not shown) within virtual machines (not shown). Some aspects may provide that the hypervisor is executed directly by the computer processor 102, while in some aspects the hypervisor may be executed within an operating system (not shown) executed directly by the computer processor 102.

Under some circumstances, such as those in which the computer processing system 100 is responsible for executing mission-critical software applications (not shown), the system availability of the computer processing system 100 may be of critical importance. Consequently, it is desirable to minimize any system downtime of the computer processing system 100. However, in conventional computer architectures, repairs and/or upgrades to particular elements of the computer processing system 100 may require that the computer processing system 100 be taken offline for the duration of the maintenance activity, resulting in a negative effect on system availability. In particular, removal and replacement of one of the memory modules 110(0)-110(X) in conventional computer architectures may require that the entire computer processing system 100 be shut down. System downtime of the computer processing system 100 may be further exacerbated in circumstances in which maintenance to the memory modules 110(0)-110(X) is necessitated by an unexpected or unpredicted memory health condition.

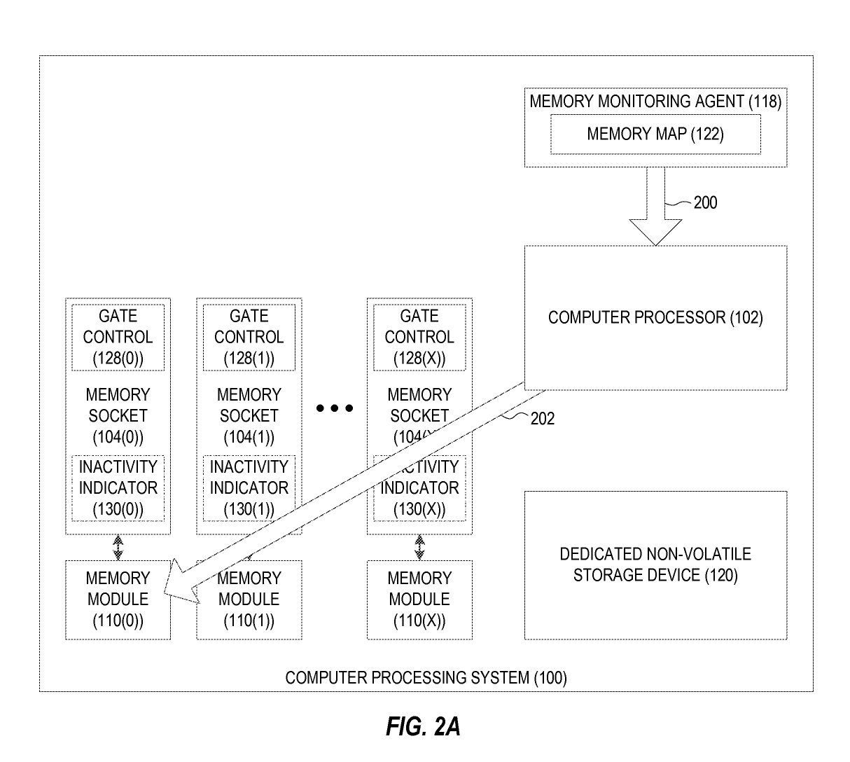

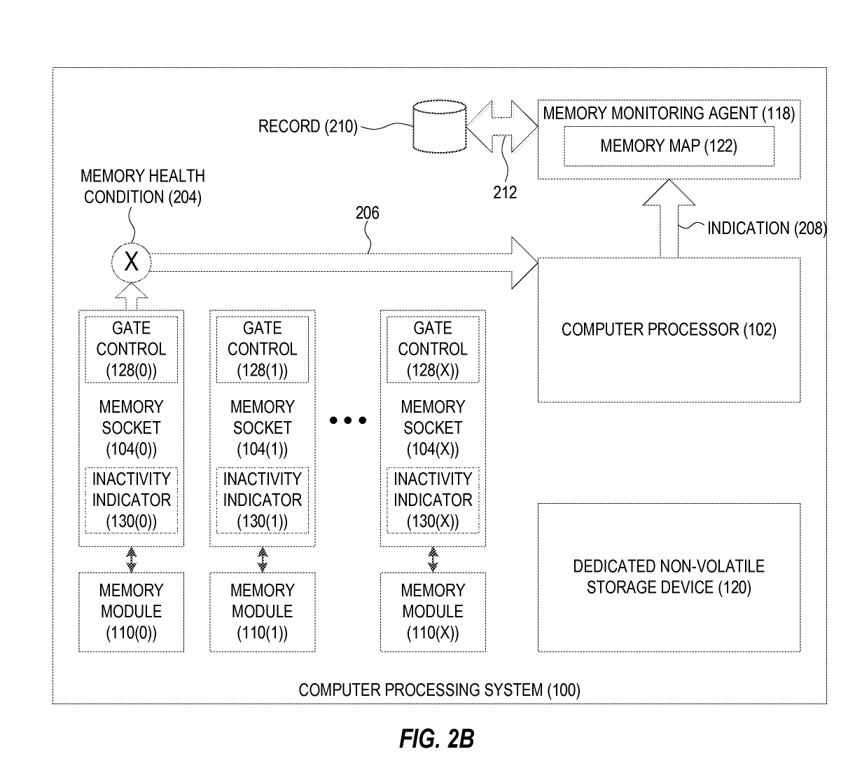

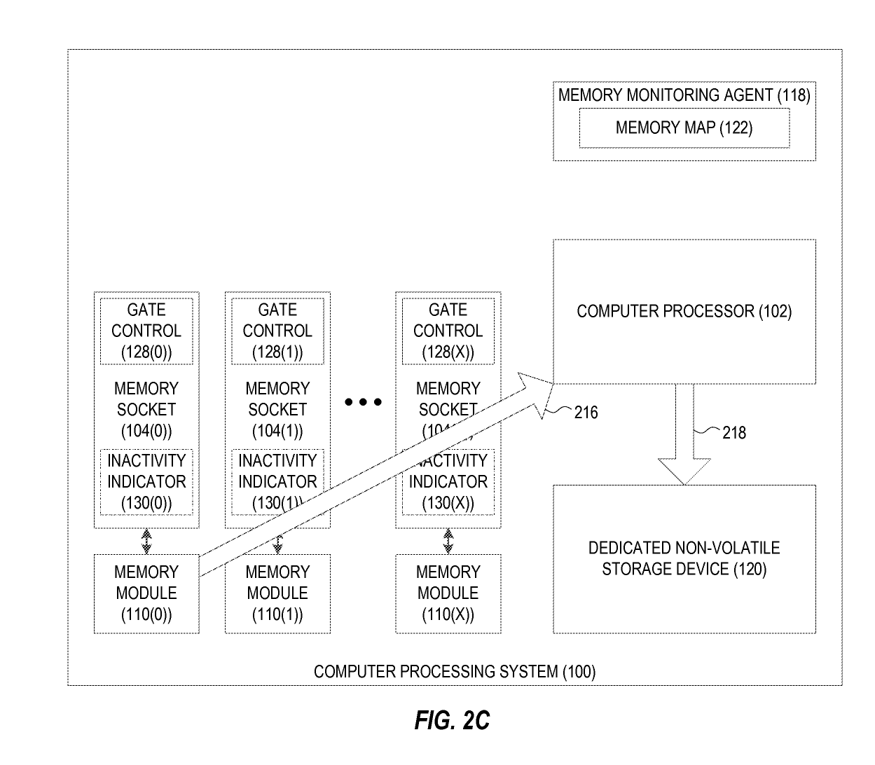

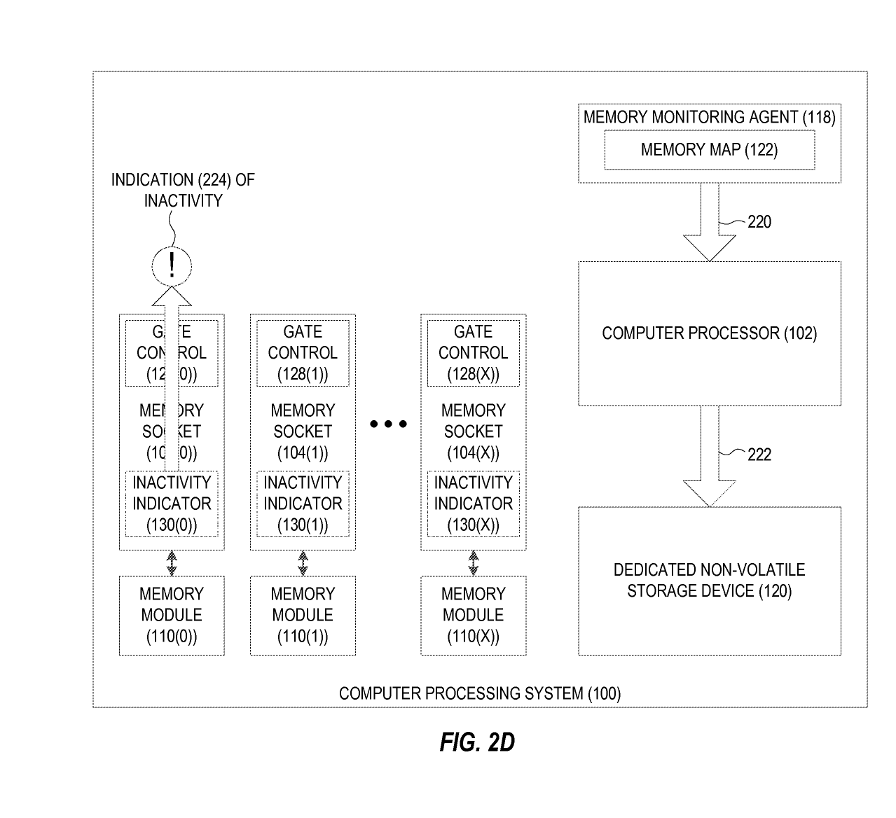

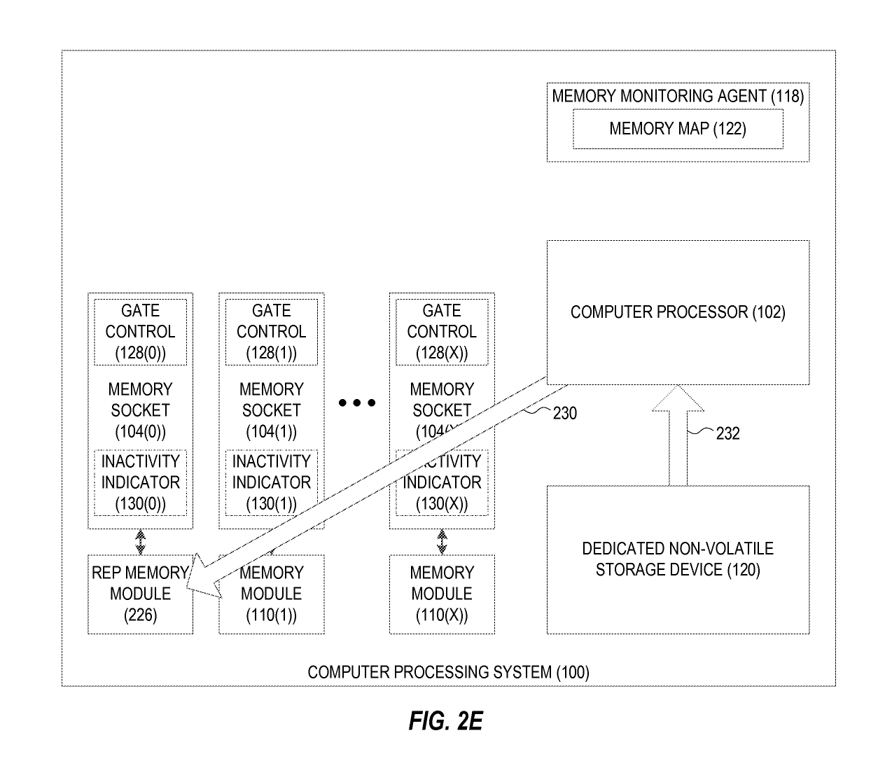

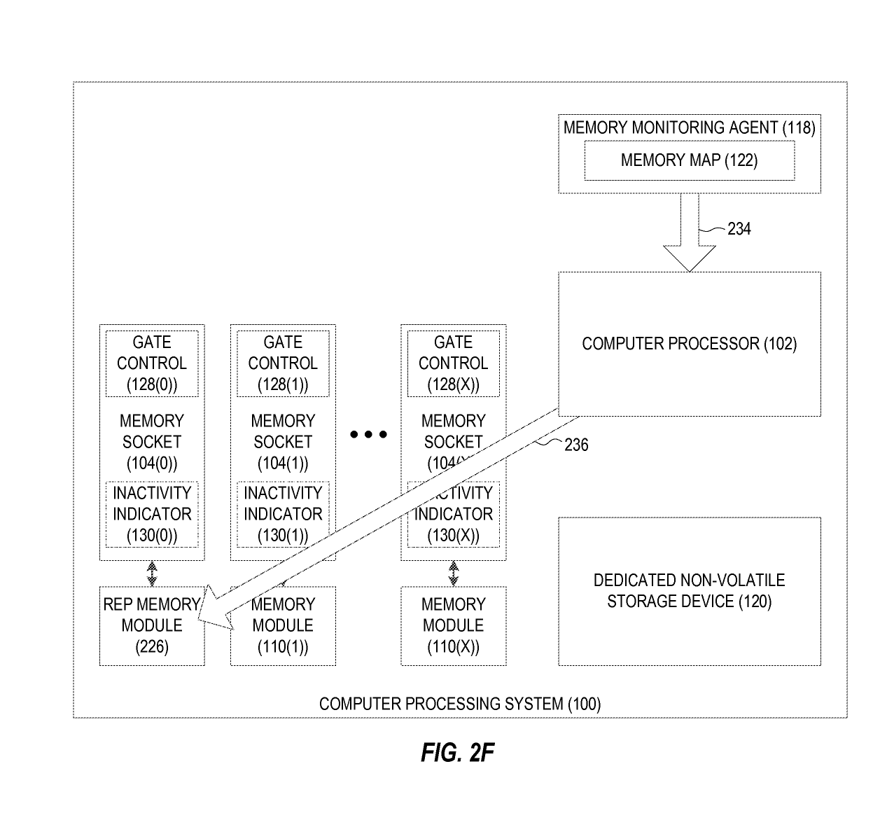

Accordingly, in this regard, the computer processing system 100 provides a memory monitoring agent 118 and a dedicated non-volatile storage device 120, each of which may work in conjunction with the computer processor 102 to facilitate memory subsystem maintenance while reducing system downtime. According to some aspects, the memory monitoring agent 118 may comprise appropriately configured software, firmware, and/or hardware, and is responsible for monitoring a health status of each of the memory modules 110(0)-110(X). For instance, the memory monitoring agent 118 may reside within a hypervisor and/or an operating system executed by or communicatively coupled to the computer processor 102, as non-limiting examples. As part of monitoring the health status of the memory modules 110(0)-110(X), the memory monitoring agent 118 may track elements such as, but not limited to, correctable memory errors, uncorrectable memory errors, environmental conditions such as temperature levels and/or voltage levels, indications of memory module performance, calibration values, and/or user-initiated upgrade requests. As discussed in greater detail below with respect to FIGS. 2A-2F, the memory monitoring agent 118 also provides a memory map 122 that enables the memory monitoring agent 118 to manage mapping of memory address ranges to the memory modules 110(0)-110(X) and the dedicated non-volatile storage device 120.

To reduce system downtime of the computer processing system 100 of FIG. 1 during memory subsystem maintenance, the dedicated non-volatile storage device 120 of FIG. 1 may be used as a temporary replacement for one of the memory modules 110(0)-110(X) during maintenance operations. As seen in FIG. 1, the dedicated non-volatile storage device 120 is communicatively coupled to a high-speed serial input/output (I/O) controller 124 of the computer processor 102 via a high-speed serial device channel 126. In some aspects, the dedicated non-volatile storage device 120 comprises an SSD or other Flash-memory-based storage device, as non-limiting examples. Some aspects may provide that, as a data security measure, the dedicated non-volatile storage device 120 is affixed to or otherwise integrated into the computer processing system 100 so as to be non-removable from the computer processing system 100. According to some aspects disclosed herein, the high-speed serial I/O controller 124 may be configured to transmit data via the high-speed serial device channel 126 according to a bus standard such as Peripheral Component Interconnect Express (PCIe), Serial AT Attachment (SATA), and Non-Volatile Memory Express (NVMe), as non-limiting examples.

The memory sockets 104(0)-104(X) further provide gate controls 128(0)-128(X), respectively, to facilitate “live” maintenance of the memory modules 110(0)-110(X). Each of the gate controls 128(0)-128(X) is configured to cause voltage gating to be applied and removed to each of the corresponding memory sockets 104(0)-104(X) at the direction of the computer processor 102. In some aspects, the gate controls 128(0)-128(X) may also be configured to cause the application and removal of clock gating of the memory sockets 104(0)-104(X), respectively. In this manner, the computer processor 102 may deactivate one of the memory sockets 104(0)-104(X) by removing power (and, optionally, a clock signal) while leaving the remaining memory sockets 104(0)-104(X) operational.

According to some aspects, the memory sockets 104(0)-104(X) may also provide inactivity indicators 130(0)-130(X), respectively, which may be configured to provide a physically-detectable indication to a user that the corresponding memory socket 104(0)-104(X) is inactive. In some aspects, the inactivity indicators 130(0)-130(X) may comprise light-emitting diodes (LEDs) configured to provide a visual indication of inactive memory sockets 104(0)-104(X). An information technology (IT) professional performing maintenance to the computer processing system 100 thus may be able to readily identify which of the memory sockets 104(0)-104(X) is interfaced with a memory module 110(0)-110(X) that requires maintenance.

To provide a conceptual illustration of exemplary operations of the memory monitoring agent 118 and the computer processing system 100 of FIG. 1 for enabling live memory module replacement in response to detection of a memory health condition, FIGS. 2A-2F are provided. In particular, FIGS. 2A-2F illustrate interactions between the memory monitoring agent 118 and the computer processor 102 of FIG. 1 in detecting and addressing a memory health condition, while allowing the computer processing system 100 to continue operating. For the sake of clarity, some elements of FIG. 1 are referenced in illustrating the operations of FIGS. 2A-2F, while some elements of FIG. 1 have been omitted.

FIG. 2A illustrates the operation of the computer processing system 100 of FIG. 1 under normal operating circumstances. The memory monitoring agent 118 may be configured to process memory access requests to a memory module 110(0) of the computer processing system 100 from currently executing processes (not shown). To accomplish this, the memory monitoring agent 118 is configured to provide the memory map 122 that may be used to map virtual memory addresses (not shown) to physical memory addresses (not shown) associated with the memory module 110(0). Accordingly, as indicated by arrows 200 and 202 in FIG. 2A, the memory map 122 may be employed by the memory monitoring agent 118 to enable access to data in the memory module 110(0).

In FIG. 2B, the computer processor 102 detects a memory health condition 204, as indicated by arrow 206, and identifies the memory module 110(0) interfaced with the memory socket 104(0) as a source of the memory health condition 204. According to some aspects, the memory health condition 204 may comprise a correctable memory error or an uncorrectable memory error occurring within the memory module 110(0), as non-limiting examples. Some aspects may provide that the memory health condition 204 is not an express error condition, but rather may comprise an environmental condition under which the memory module 110(0) is operating, such as a temperature level or a voltage level, as non-limiting examples. The memory health condition 204 according to some aspects may comprise an indication of performance of the memory module 110(0), such as a calibration value or a performance counter, as a non-limiting example. In some aspects, the memory health condition 204 may comprise a condition initiated by a user, such as a user-initiated upgrade request, as a non-limiting example.

As seen in FIG. 2B, the memory monitoring agent 118, in the course of monitoring the health status of the memory modules 110(0)-110(X), receives an indication 208 of the memory health condition 204 of the memory module 110(0) from the computer processor 102. In some aspects, the memory monitoring agent 118 is configured to maintain a record 210 of the occurrence of memory health conditions such as the memory health condition 204, as indicated by bidirectional arrow 212. In this manner, the memory monitoring agent 118 may track the health status of the memory modules 110(0)-110(X) over time.

The memory monitoring agent 118 may then determine, based on the indication 208, whether the memory health condition 204 warrants replacement of the memory module 110(0). In some aspects, determining whether replacement of the memory module 110(0) is warranted may be based on one or more of a memory health condition threshold and a user-provided replacement indication, as non-limiting examples. For instance, the determination may be based on determining whether or not the record 210 shows that a number of detected error-related memory health conditions exceeds a memory health condition threshold, or whether or not the record 210 indicates an over- or under-utilization of the memory modules 110(0)-110(X), as non-limiting examples. If the memory monitoring agent 118 determines that no action is necessary, operations of the computer processing system 100 continue as before, with the memory monitoring agent 118 continuing to monitor the health status of the memory modules 110(0)-110(X) and update the record 210 as needed. However, if the memory monitoring agent 118 determines that replacement of the memory module 110(0) is appropriate, a sequence of operations is initiated to facilitate removal and replacement of the memory module 110(0) while reducing system downtime of the computer processing system 100. This sequence of operations is shown in FIGS. 2C-2F.

Referring now to FIG. 2C, the memory monitoring agent 118 first blocks access to a memory address range of the memory module 110(0) based on receiving the indication 208 of the memory health condition 204 as seen in FIG. 2B. By blocking access to the memory address range of the memory module 110(0), the contents of the memory module 110(0) are rendered inaccessible to currently executing processes (not shown). The memory monitoring agent 118 then initiates a transfer of data stored in the memory module 110(0) to the dedicated non-volatile storage device 120, as indicated by arrows 216 and 218. The data transfer is performed by the computer processor 102 using, for example, the memory bus 106, the memory controller 108, the high-speed serial I/O controller 124, and the high-speed serial device channel 126 of FIG. 1.

In FIG. 2D, the memory monitoring agent 118, using the memory map 122, remaps the memory address range of the memory module 110(0) to the dedicated non-volatile storage device 120, as indicated by arrows 220 and 222. As a result, memory access requests (not shown) from currently executing processes to the memory module 110(0) are rerouted to the dedicated non-volatile storage device 120. Thus, the executing processes may continue uninterrupted execution while maintenance is performed on the memory module 110(0).

To facilitate replacement of the memory module 110(0), the memory monitoring agent 118 next may initiate voltage gating (and, optionally, clock gating) of the memory socket 104(0) of the memory module 110(0). In some aspects, voltage gating and/or clock gating may be carried out by the computer processor 102 using the gate control 128(0) of the memory socket 104(0). After the voltage gating and/or clock gating has been applied to the memory socket 104(0), the computer processor 102 according to some aspects may provide an indication 224 of inactivity, using the inactivity indicator 130(0) of the memory socket 104(0). The indication 224 may provide a visual indication that the memory module 110(0) is inactive. Some aspects may provide that the inactivity indicator 130(0) may comprise an LED providing a visual inactivity indication such as a blinking light, as a non-limiting example. The indication 224 may assist an IT technician with positively identifying the memory module 110(0) for maintenance.

Turning to FIG. 2E, in this example the memory module 110(0) has been substituted with a replacement memory module (REP MEMORY MODULE) 226 to address and/or correct the memory health condition 204. In some aspects, the computer processor 102 may then reactivate the memory socket 104(0) by removing voltage gating and/or clock gating to the memory socket 104(0) using the gate control 128(0) of the memory socket 104(0). Some aspects may also provide that the computer processor 102 may cause an initialization procedure and/or a training procedure to be performed on the replacement memory module 226 to prepare the replacement memory module 226 for operation.

The memory monitoring agent 118 and the computer processor 102 then transfer data from the dedicated non-volatile storage device 120 to the replacement memory module 226. The memory monitoring agent 118 blocks access to the memory address range that was remapped to the dedicated non-volatile storage device 120. In this manner, the contents of the dedicated non-volatile storage device 120 are rendered inaccessible to executing processes. The memory monitoring agent 118 then initiates a transfer of data from the dedicated non-volatile storage device 120 to the replacement memory module 226, as indicated by arrows 230 and 232. As noted above, the data transfer may be performed by the computer processor 102 using, for example, the memory bus 106, the memory controller 108, the high-speed serial I/O controller 124, and the high-speed serial device channel 126 of FIG. 1.

Referring now to FIG. 2F, the memory monitoring agent 118 may then use the memory map 122 to remap the memory address range of the dedicated non-volatile storage device 120 to the replacement memory module 226, as indicated by arrows 234 and 236. The computer processing system 100 may then resume operations using the replacement memory module 226. Because the computer processing system 100 did not have to be taken offline in order for replacement of the memory module 110(0) to be performed, the system downtime for the computer processing system 100 is reduced compared to performing similar maintenance on a conventional computer processing system.

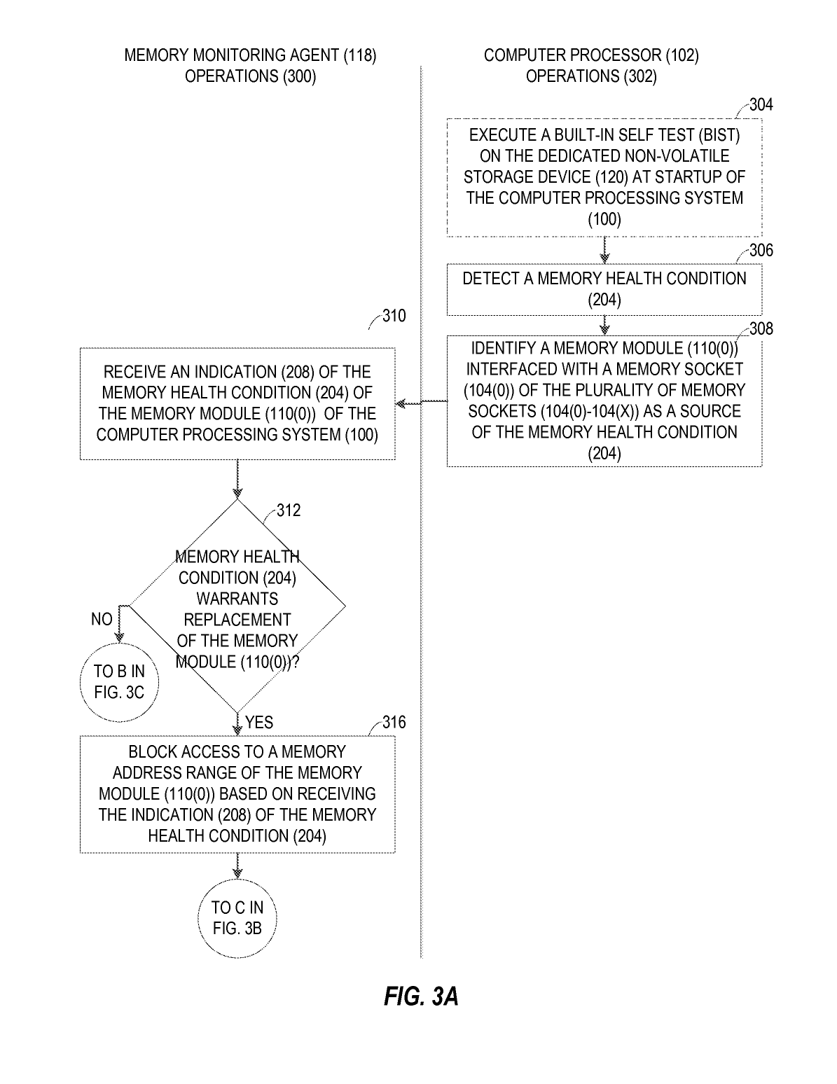

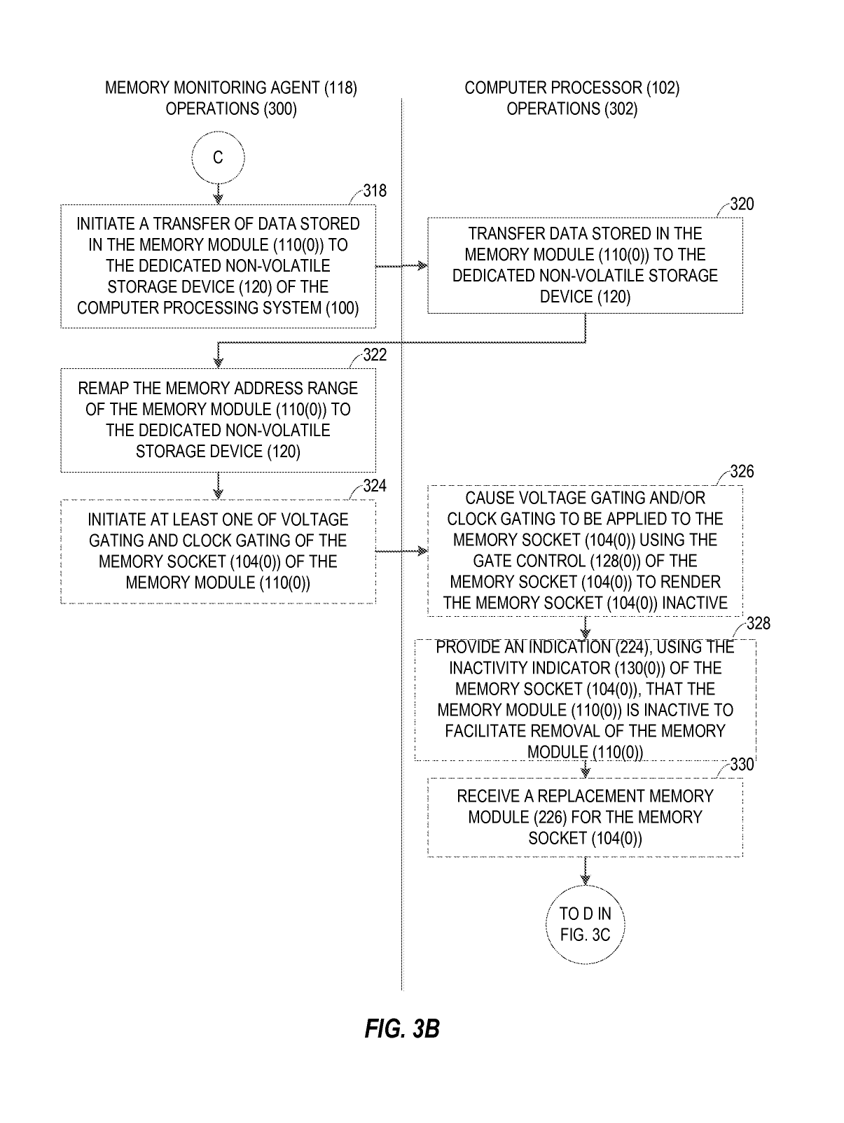

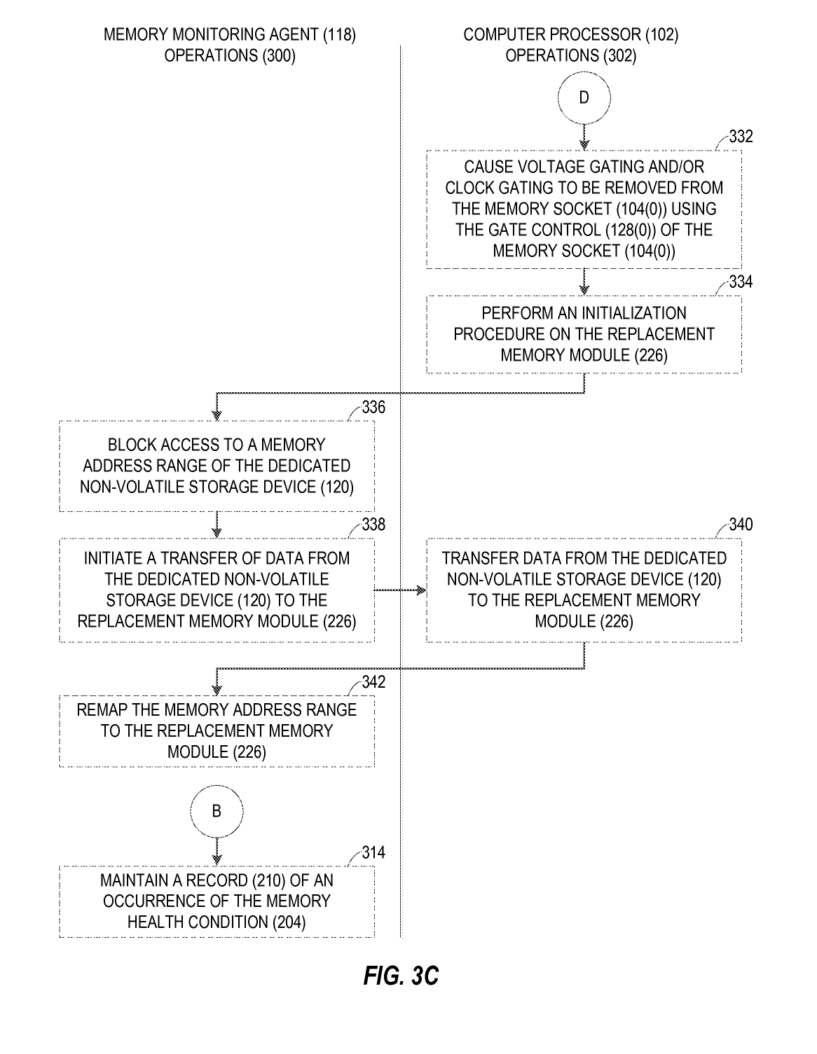

FIGS. 3A-3C are provided to further illustrate exemplary operations by the memory monitoring agent 118 and the computer processor 102 of FIG. 1 for monitoring memory health conditions and enabling live memory subsystem maintenance. In FIGS. 3A-3C, operations carried out by the memory monitoring agent 118 in some aspects are represented by blocks in column 300, while operations performed by hardware elements such as the computer processor 102 of FIG. 1 are represented by blocks in column 302. It is to be understood, however, that the division of operations between the memory monitoring agent 118 and the computer processor 102 in some aspects may differ from that illustrated in FIGS. 3A-3C. For example, some or all operations depicted in the column 300 may be performed by appropriately configured firmware or hardware according to some aspects. For the sake of clarity, elements of FIGS. 1 and 2A-2F are referenced in describing FIGS. 3A-3C.

In FIG. 3A, operations begin with the computer processor 102 optionally executing a built-in self test (BIST) on the dedicated non-volatile storage device 120 at startup of the computer processing system 100 (block 304). The BIST may be performed to confirm the reliability of the dedicated non-volatile storage device 120 should it be needed as temporary memory during maintenance to one of the memory modules 110(0)-110(X). The computer processor 102 subsequently detects a memory health condition 204 during operation of the computer processing system 100 (block 306). The memory health condition 204 may comprise, as non-limiting examples, a correctable memory error, an uncorrectable memory error, an environmental condition such as a temperature level and/or a voltage level, an indication of memory module performance, a calibration value, and/or a user-initiated upgrade request. In response to detecting the memory health condition 204, the computer processor 102 identifies one of the memory modules 110(0)-110(X), such as the memory module 110(0) interfaced with the memory socket 104(0) of the plurality of memory sockets 104(0)-104(X), as a source of the memory health condition 204 (block 308).

The memory monitoring agent 118 then receives an indication 208 of the memory health condition 204 of the memory module 110(0) from the computer processor 102 (block 310). Based on the indication 208 of the memory health condition 204, the memory monitoring agent 118 determines whether the memory health condition 204 warrants replacement of the memory module 110(0) (block 312). As noted above, this determination may be based on determining whether or not a number of error-related memory health conditions exceeds a memory health condition threshold, or whether or not the record 210 indicates an over- or under-utilization of the memory modules 110(0)-110(X), as non-limiting examples. If replacement of the memory module 110(0) is determined to be unwarranted at decision block 312, processing continues at block 314 of FIG. 3C. Referring briefly to FIG. 3C, the memory monitoring agent 118 may maintain a record 210 of the occurrence of the memory health condition 204 (block 314). The memory monitoring agent 118 may then return to monitoring the health status of the memory modules 110(0)-110(X). Returning to FIG. 3A, if the memory monitoring agent 118 determines at decision block 312 that replacement of the memory module 110(0) is warranted, the memory monitoring agent 118 blocks access to a memory address range of the memory module 110(0) based on receiving the indication 208 of the memory health condition 204 (block 316). Processing then resumes at block 318 of FIG. 3B.

In FIG. 3B, the memory monitoring agent 118 initiates a transfer of data stored in the memory module 110(0) to the dedicated non-volatile storage device 120 of the computer processing system 100 (block 318). In response, the computer processor 102 transfers data from the memory module 110(0) to the dedicated non-volatile storage device 120 (block 320). After the data transfer is complete, the memory monitoring agent 118 remaps the memory address range of the memory module 110(0) to the dedicated non-volatile storage device 120 (block 322). According to some aspects, remapping the memory address range of the memory module 110(0) may be accomplished using the memory map 122 of FIG. 1.

According to some aspects, operations may continue with the memory monitoring agent 118 initiating at least one of voltage gating and clock gating of the memory socket 104(0) of the memory module 110(0) (block 324). As a result, the computer processor 102 may cause voltage gating and/or clock gating to be applied to the memory socket 104(0) using the gate control 128(0) of the memory socket 104(0) to render the memory socket 104(0) inactive (block 326). The computer processor 102 may then provide an indication 224, using the inactivity indicator 130(0) of the memory socket 104(0), that the memory module 110(0) is inactive to facilitate removal of the memory module 110(0) (block 328). As noted above, the inactivity indicators 130(0)-130(X) may comprise an LED configured to provide a visual indication of the inactive status of the memory socket 104(0). The memory socket 104(0) may then receive a replacement memory module 226 for the memory socket 104(0) (block 330). Processing may then resume at block 332 of FIG. 3C.

Referring now to FIG. 3C, the computer processor 102 may remove voltage gating and/or clock gating to the memory socket 104(0) using the gate control 128(0) of the memory socket 104(0) (block 332). The computer processor 102 may optionally perform an initialization procedure on the replacement memory module 226, to ensure that the replacement memory module 226 is functional (block 334). The memory monitoring agent 118 then blocks access to the memory address range of the dedicated non-volatile storage device 120 (block 336). A transfer of data from the dedicated non-volatile storage device 120 to the replacement memory module 226 is initiated by the memory monitoring agent 118 (block 338). In response, the computer processor 102 transfers data from the dedicated non-volatile storage device 120 to the replacement memory module 226 (block 340). The memory monitoring agent 118 may then remap the memory address range to the replacement memory module 226 (block 342).

Reducing system downtime during memory subsystem maintenance, according to aspects disclosed herein, may be provided in or integrated into any processor-based device. Examples, without limitation, include a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

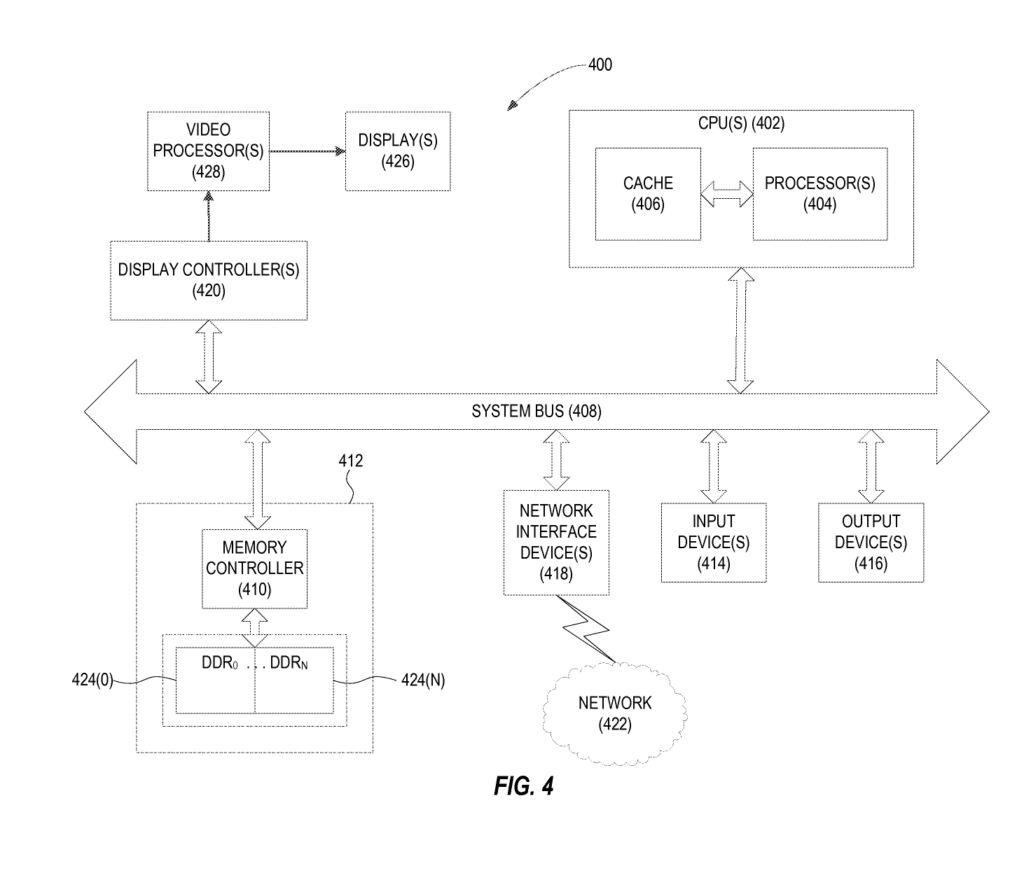

In this regard, FIG. 4 illustrates an example of a processor-based system 400 that may comprise the computer processing system 100 illustrated in FIG. 1. In this example, the processor-based system 400 includes one or more central processing units (CPUs) 402, each including one or more processors 404. In some aspects, the one or more processors 404 may comprise the computer processor 102 of FIG. 1. The one or more processors 404 may include the computer processor 102 of FIGS. 1 and 2A-2C. The CPU(s) 402 may be a master device. The CPU(s) 402 may have cache memory 406 coupled to the processor(s) 404 for rapid access to temporarily stored data. The CPU(s) 402 is coupled to a system bus 408 and can intercouple master and slave devices included in the processor-based system 400. As is well known, the CPU(s) 402 communicates with these other devices by exchanging address, control, and data information over the system bus 408. For example, the CPU(s) 402 can communicate bus transaction requests to a memory controller 410 as an example of a slave device.

Other master and slave devices can be connected to the system bus 408. As illustrated in FIG. 4, these devices can include a memory system 412, one or more input devices 414, one or more output devices 416, one or more network interface devices 418, and one or more display controllers 420, as examples. The input device(s) 414 can include any type of input device, including but not limited to input keys, switches, voice processors, etc. The output device(s) 416 can include any type of output device, including but not limited to audio, video, other visual indicators, etc. The network interface device(s) 418 can be any devices configured to allow exchange of data to and from a network 422. The network 422 can be any type of network, including but not limited to a wired or wireless network, a private or public network, a local area network (LAN), a wide local area network (WLAN), and the Internet. The network interface device(s) 418 can be configured to support any type of communications protocol desired. The memory system 412 can include one or more memory units 424(0-N), which, in some aspects, may comprise the memory sockets 104(0)-104(X) and the memory modules 110(0)-110(X) of FIG. 1.

The CPU(s) 402 may also be configured to access the display controller(s) 420 over the system bus 408 to control information sent to one or more displays 426. The display controller(s) 420 sends information to the display(s) 426 to be displayed via one or more video processors 428, which process the information to be displayed into a format suitable for the display(s) 426. The display(s) 426 can include any type of display, including but not limited to a cathode ray tube (CRT), a liquid crystal display (LCD), a plasma display, etc.

Those of skill in the art will further appreciate that the various illustrative logical blocks, modules, circuits, and algorithms described in connection with the aspects disclosed herein may be implemented as electronic hardware, instructions stored in memory or in another computer-readable medium and executed by a processor or other processing device, or combinations of both. The master and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flow chart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A computer processing system, comprising:
a plurality of memory sockets, each comprising a gate control and configured to interface with a memory module;
a dedicated non-volatile storage device; and
a computer processor communicatively coupled to the plurality of memory sockets and the dedicated non-volatile storage device;
the computer processor configured to:
detect a memory health condition for a memory module interfaced with a memory socket among the plurality of memory sockets;
identify the memory module interfaced with the memory socket of the plurality of memory sockets as a source of the memory health condition;
transfer data stored in the memory module to the dedicated non-volatile storage device; and
cause voltage gating to be applied to the memory socket using the gate control of the memory socket to render the memory socket inactive.

2. The computer processing system of claim 1, wherein the computer processor is further configured to cause clock gating to be applied to the memory socket using the gate control of the memory socket.

3. The computer processing system of claim 1, wherein the computer processor is communicatively coupled to the dedicated non-volatile storage device via a high-speed serial device channel.

4. The computer processing system of claim 3, wherein the high-speed serial device channel is configured to operate according to a bus standard selected from the group consisting of: Peripheral Component Interconnect Express (PCIe); Serial AT Attachment (SATA); and Non-Volatile Memory Express (NVMe).

5. The computer processing system of claim 1, wherein:
each of the plurality of memory sockets further comprises an inactivity indicator; and
the computer processor is further configured to provide an indication, using the inactivity indicator of the memory socket, that the memory module is inactive to facilitate removal of the memory module.

6. The computer processing system of claim 1, wherein the computer processor is further configured to, responsive to the memory socket receiving a replacement memory module:
restore power to the memory socket using the gate control of the memory socket;
perform an initialization procedure on the replacement memory module; and
transfer data from the dedicated non-volatile storage device to the replacement memory module.

7. The computer processing system of claim 1, wherein the computer processor is configured to detect the memory health condition by detecting, for the memory module interfaced with the memory socket of the plurality of memory sockets, at least one of the group consisting of a correctable memory error, an uncorrectable memory error, a temperature level, a voltage level, an indication of performance, a calibration value, and a user-initiated upgrade request, or any combination thereof.

8. The computer processing system of claim 1, wherein the computer processor is further configured to execute a built-in self test (BIST) on the dedicated non-volatile storage device at startup of the computer processing system.

9. The computer processing system of claim 1 integrated into an integrated circuit (IC).

10. The computer processing system of claim 1 integrated into a device selected from the group consisting of: a set top box; an entertainment unit; a navigation device; a communications device; a fixed location data unit; a mobile location data unit; a mobile phone; a cellular phone; a computer; a portable computer; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; and a portable digital video player.

11. A computer processing system, comprising:
a means for detecting a memory health condition for a memory module interfaced with a memory socket among a plurality of memory sockets;
a means for identifying the memory module interfaced with the memory socket of the plurality of memory sockets as a source of the memory health condition;
a means for transferring data stored in the memory module to a dedicated non-volatile storage device; and
a means for causing voltage gating to be applied to the memory socket to render the memory socket inactive.

12. The computer processing system of claim 11, further comprising a means for causing clock gating to be applied to the memory socket.

13. The computer processing system of claim 11, further comprising a means for providing an indication that the memory module is inactive to facilitate removal of the memory module.

14. The computer processing system of claim 11, further comprising:
a means for restoring power to the memory module of the memory socket, responsive to the memory socket receiving a replacement memory module;
a means for performing an initialization procedure on the replacement memory module; and
a means for transferring data from the dedicated non-volatile storage device to the replacement memory module.

15. The computer processing system of claim 11, wherein the means for detecting the memory health condition comprises a means for detecting, for the memory module interfaced with the memory socket of the plurality of memory sockets, at least one of the group consisting of a correctable memory error, an uncorrectable memory error, a temperature level, a voltage level, an indication of performance, a calibration value, and a user-initiated upgrade request, or any combination thereof.

16. The computer processing system of claim 11, further comprising a means for executing a built-in self test (BIST) on the dedicated non-volatile storage device at startup of the computer processing system.

17. A method for facilitating maintenance of a computer processing system, comprising:
receiving an indication of a memory health condition of a memory module of a plurality of memory modules of a computer processing system;
determining whether the memory health condition warrants replacement of the memory module; and
responsive to determining that the memory health condition warrants the replacement of the memory module:
blocking access to a memory address range of the memory module based on receiving the indication of the memory health condition;
initiating a transfer of data stored in the memory module to a dedicated non-volatile storage device of the computer processing system; and
remapping the memory address range of the memory module to the dedicated non-volatile storage device.

18. The method of claim 17, further comprising initiating at least one of voltage gating and clock gating of a memory socket of the memory module.

19. The method of claim 17, further comprising:
blocking access to the memory address range of the dedicated non-volatile storage device;
initiating a transfer of data from the dedicated non-volatile storage device to a replacement memory module; and
remapping the memory address range to the replacement memory module.

20. The method of claim 17, wherein receiving the indication of the memory health condition comprises receiving an indication of, for the memory module of the plurality of memory modules, at least one of the group consisting of a correctable memory error, an uncorrectable memory error, a temperature level, a voltage level, an indication of performance, a calibration value, and a user-initiated upgrade request, or any combination thereof.

21. The method of claim 17, further comprising, responsive to determining that the memory health condition does not warrant the replacement of the memory module, maintaining a record of an occurrence of the memory health condition.

22. The method of claim 17, wherein determining whether the memory health condition warrants the replacement of the memory module is based on at least one of a memory health condition threshold and a user-provided replacement indication.

23. A non-transitory computer-readable medium having stored thereon computer executable instructions which, when executed by a processor, cause the processor to:
receive an indication of a memory health condition of a memory module of a plurality of memory modules of a computer processing system;
determine whether the memory health condition warrants replacement of the memory module; and
responsive to determining that the memory health condition warrants the replacement of the memory module:
block access to a memory address range of the memory module based on receiving the indication of the memory health condition;
initiate a transfer of data stored in the memory module to a dedicated non-volatile storage device of the computer processing system; and
remap the memory address range of the memory module to the dedicated non-volatile storage device.

24. The non-transitory computer-readable medium of claim 23 having stored thereon computer-executable instructions which, when executed by the processor, further cause the processor to initiate at least one of voltage gating and clock gating of a memory socket of the memory module.

25. The non-transitory computer-readable medium of claim 23 having stored thereon computer-executable instructions which, when executed by the processor, further cause the processor to:
block access to the memory address range of the dedicated non-volatile storage device;
initiate a transfer of data from the dedicated non-volatile storage device to a replacement memory module; and
remap the memory address range to the replacement memory module.

26. The non-transitory computer-readable medium of claim 23 having stored thereon computer-executable instructions which, when executed by the processor, further cause the processor to receive the indication of the memory health condition by receiving an indication of, for the memory module of the plurality of memory modules, at least one of the group consisting of a correctable memory error, an uncorrectable memory error, a temperature level, a voltage level, an indication of performance, a calibration value, and a user-initiated upgrade request, or any combination thereof.

27. The non-transitory computer-readable medium of claim 23 having stored thereon computer-executable instructions which, when executed by the processor, further cause the processor to, responsive to determining that the memory health condition does not warrant the replacement of the memory module, maintain a record of an occurrence of the memory health condition.

28. The non-transitory computer-readable medium of claim 23 having stored thereon computer-executable instructions which, when executed by the processor, further cause the processor to determine whether the memory health condition warrants the replacement of the memory module based on at least one of a memory health condition threshold and a user-provided replacement indication.
